(19) United States
(12) Patent Application Publication
(10) Pub. No.: US 2009/0189743 A1
(43) Pub. Date: Jul. 30, 2009

(54) Radio-Frequency Identification Enabled Inventory Management and Network Operations System and Method

(75) Inventors: Cherian Abraham, Plano, TX (US); Fred Eubanks, McKinney, TX (US); Wayne L. Laffitte, Murphy, TX (US)

Correspondence Address: HITT GAINES, PC;ALCATEL-LUCENT, PO BOX 832570, RICHARDSON, TX, 75083, US

(73) Assignee: Alcatel-Lucent, Paris (FR)

(21) Appl. No.: 12/019,088

(22) Filed: Jan. 24, 2008

(51) Int. Cl. G06Q 10/00; H04Q 5/22

(52) U.S. Cl. 340/10.42; 340/5.92; 340/572.1

(57) ABSTRACT

An inventory management and network operations system and method. In one embodiment, the system includes: (1) a radio-frequency identification (RFID) reader data network having RFID readers configured to read tag identifiers from RFID tags associated with equipment to be deployed to a target network and (2) a computer coupled to the RFID reader data network and the target network and configured to retrieve the tag identifiers from the RFID reader data network and network identifiers from equipment deployed in the target network, associate the tag identifiers and the network identifiers and display both the tag identifiers and the network identifiers of at least some of the equipment to a user.

### TECHNICAL FIELD OF THE INVENTION

The invention is directed, in general, to inventory and network operations management and, more specifically, to a radio-frequency identification (RFID) enabled inventory management and network operations system and method.

### BACKGROUND OF THE INVENTION

Service providers, such as wireline and wireless telecommunication service providers, cable television companies and Internet service providers (ISPs), are responsible for establishing, maintaining and operating networks. As part of that effort, inventories and installations of equipment must be acquired and managed (e.g., manufactured, transported, stored, deployed, secured, monitored, tested, repaired, removed and retired). “Equipment,” as that term is used herein, includes not only cables, network-level equipment (such may be used in a central office or a “hut”) and end-user equipment (sometimes referred to as customer premises equipment, or CPE). Depending upon the type of network, end-user equipment includes set-top boxes, or converters, modems or routers, telephone network interfaces (TNIs), optical network terminals (ONTs), telephones and cellphones. “Equipment” also includes test equipment and any mounting structures (such as racks or cabinets), subassemblies (such as cards) or parts for the aforementioned cables and equipment.

Because large networks may span multiple countries and continents, the task of acquiring and managing equipment can be daunting. Since service providers frequently work with other companies, the resulting web of companies and processes by which such equipment and parts are manufactured, transported, stored, deployed, secured, monitored, tested, repaired, reworked, modified updated, removed, retired and destroyed is known as a supply chain. A complete supply chain for a service provider may be regarded as a combination of two related supply chains: a forward supply chain by which equipment is manufactured, transported, stored and deployed to the network, and a repair and return supply chain by which equipment is tested, repaired, reworked, modified, updated, removed and retired from the network. Consequently, service providers use relatively sophisticated software systems to track equipment and parts.

Inventory management systems may be employed to manage at least parts of a supply chain. Unfortunately, existing inventory management systems rely to a large extent on human beings to gather their data manually. Further, because the effort of manual data entry is relatively high, such systems tend to call for data to be gathered at relatively few points in the supply chain. As a consequence, existing inventory management systems offer a limited, and frequently flawed, understanding of the state of the supply chain. Such systems are particularly ill-suited to manage inventories of equipment that include equipment that is deployed in a network.

Accordingly, what is needed in the art is a better way to gather and present information regarding and manage the constant movement of inventories of equipment in a network. More specifically, what is needed in the art is a comprehensive inventory management and network operations system and a method of managing inventories of telecommunications or computer equipment and operating a telecommunications or computer network.

### SUMMARY OF THE INVENTION

To address the above-discussed deficiencies of the prior art, one aspect of the invention provides an inventory management and network operations system. In one embodiment, the system includes: (1) a RFID reader data network having RFID readers configured to read tag identifiers from RFID tags associated with equipment to be deployed to a target network and (2) a computer coupled to the RFID reader data network and the target network and configured to retrieve the tag identifiers from the RFID reader data network and network identifiers from equipment deployed in the target network, associate the tag identifiers and the network identifiers and display both the tag identifiers and the network identifiers of at least some of the equipment to a user.

In another embodiment, the system includes: (1) an RFID reader data network having RFID readers configured to read tag identifiers from REID tags associated with equipment to be deployed to a target network and (2) a computer coupled to the RFID reader data network and the target network and configured to retrieve the tag identifiers from the RFID reader data network and network identifiers from equipment deployed in the target network, associate the tag identifiers and the network identifiers and display both the tag identifiers and the network identifiers of at least some of the equipment to a user and allow the user to track equipment as it is deployed to the network and removed from the network and repaired.

Another aspect of the invention provides an inventory management and network operations method. In one embodiment, the method includes: (1) reading tag identifiers from RFID tags associated with equipment to be deployed to a target network, (2) retrieving network identifiers from equipment deployed in the target network with a computer, (3) associating the tag identifiers and the network identifiers in a database and (4) displaying both the tag identifiers and the network identifiers of at least some of the equipment to a user.

### BRIEF DESCRIPTION OF THE DRAWINGS

For a more complete understanding of the invention, reference is now made to the following descriptions taken in conjunction with the accompanying drawings, in which:

FIG. 1 is a block diagram illustrating one embodiment of forward and repair-and-return supply chains that form an environment within which an RFID enabled inventory management and network operations system and method constructed or carried out according to the principles of the invention may operate;

FIG. 2 is a block diagram illustrating one embodiment of an RFID enabled inventory management and network operations system constructed according to the principles of the invention;

FIG. 3 is a more detailed block diagram of one embodiment of the RFID enabled inventory management and network operations system of FIG. 2;

FIG. 4 is a block diagram of an example RFID enabled inventory management and network operations system constructed according to the principles of the invention;

FIG. 5 is a block diagram of a PICS center/garage RFID portion of the RFID enabled inventory management and network operations system of FIG. 2;

FIG. 6 is a block diagram of a mobile RFID portion of the RFID enabled inventory management and network operations system of FIG. 2; and

FIG. 7 is a flow diagram illustrating one embodiment of an RFID enabled inventory management and network operations method carried out according to the principles of the invention.

### DETAILED DESCRIPTION

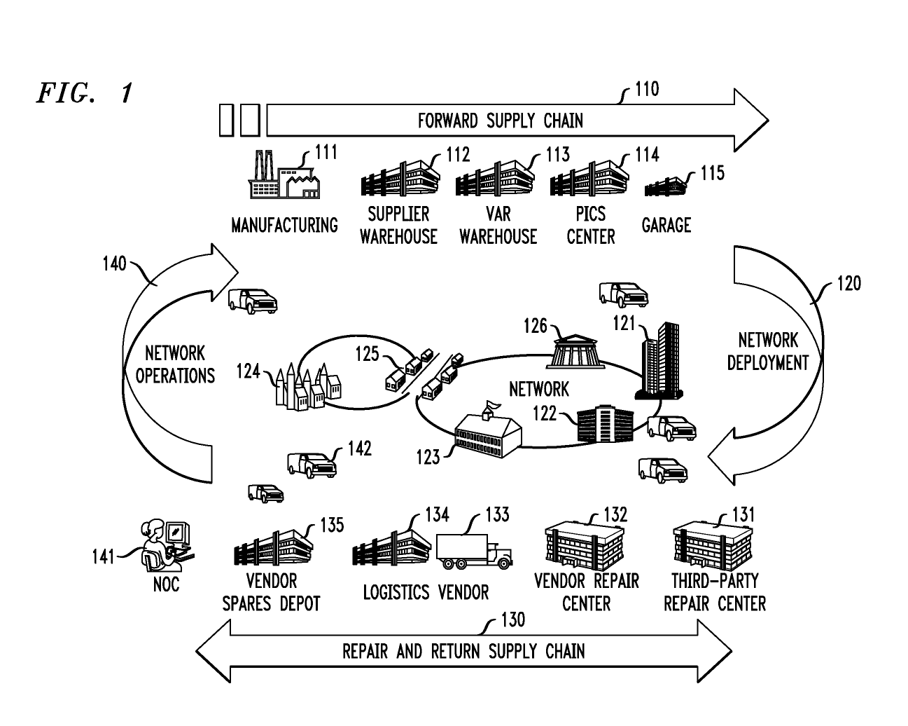

FIG. 1 is a block diagram illustrating one embodiment of forward and repair-and-return supply chains that form an environment within which an RFID enabled inventory management and network operations system and method constructed or carried out according to the principles of the invention may operate. FIG. 1 shows a forward supply chain 110, a network deployment process 120, a repair and return supply chain 130 and a network operations process 140.

The forward supply chain 110 is the channel by which equipment is introduced into a network (which for the sake of clarity will be called a “target network”) operated by a service provider. In the illustrated embodiment, the service provider is a telecommunications service provider, and the target network is a telecommunications network. Alternatively, the service provider can be of any other type.

The forward supply chain 110 encompasses a manufacturing plant 111, a supplier warehouse 112, a value-added reseller (VAR) warehouse 113, a plug-in card system (PICS) center 114 and a garage 115. All of these locations 111, 112, 113, 114, 115 are fixed locations where equipment may be made or stored. Though not shown in FIG. 1, the forward supply chain 110 may also encompass vehicles such as trucks and forklifts that may temporarily convey the equipment from one fixed location to another. Of course, a real-world forward supply chain may have multiple instances of each of these fixed locations or may lack one or more of these fixed locations and may employ any number of vehicles to move equipment thereamong.

The network deployment process 120 is the point at which where the equipment becomes installed into or removed from the target network, which happens to be a telecommunications network in the illustrated embodiment, but can be of any type. The target network employs equipment at various locations, including commercial office buildings 121, central offices (COs) 122, schools 123, towns 124, neighborhoods 125 and government installations 126.

The repair and return supply chain 130 is the channel by which equipment is removed from the target network either temporarily or permanently and encompasses third-party repair (or service deployment) centers 131, vendor repair centers 132, mobile and fixed resources 133, 134 owned and operated by a logistics vendor and vendor spare equipment depots 135.

The network operations process 140 is the point at which the operation of the target network is monitored, including the equipment installed at the commercial office buildings 121, COs 122, schools 123, towns 124, neighborhoods 125 and government installations 126. A network operations center (NOC) 141 performs the monitoring, which typically includes receiving calls indicating trouble and initiating repairs services, such as dispatching repair vehicles 142.

Although simplified, FIG. 1 still illustrates an array of different locations at which equipment may be located and processes through which equipment may pass. At any given time, different equipment is likely to be deployed to and located at each of the locations and be in various stages of each of the processes.

Due to this complexity of the deployment, monitoring and removal of equipment, service providers lack a comprehensive, end-to-end inventory management for specific parts, from purchase and delivery, to in-field installation, to repair and re-installation, to retirement. Consequently, one or more of the following problems may result: an inability to determine what equipment has been installed in the target network, an inability to validate that equipment delivered to a particular location are actually installed and put into use, an inability to be alerted when items are “lost” during transportation, an inability to correlate a target network fault and defective equipment, an inability to verify spares already loaded on service vehicles, an inability to validate test equipment or other tools loaded on service vehicles, an inability to verify service vehicle location and thus choose the optimal service vehicle for dispatch and an inability to locate equipment to at least a particular bin (a generic term including storage shelves, boxes and other types of containers or repositories).

What is needed is a comprehensive inventory management and network operations system and method that tracks and coordinates much if not all of the following: new equipment installations, equipment retrofitting, equipment augmentation or enhancement, new spare equipment, equipment retirement, unused equipment, recalled equipment, defective equipment (both in and out of warranty), “dead on arrival” equipment, repaired equipment, excess equipment, equipment with an unknown status, ubiquitous (non-serialized) equipment, improperly worked equipment, equipment removed from the target network, spare equipment removed, improperly worked additional equipment, equipment for which a different plug has been installed than was ordered, “dead on arrival” equipment plugs, short interval equipment orders, cancelled orders causing unused plugs, reissued orders causing double equipment shipments, inadequate data on equipment, ineffective equipment recall processes, perceptions of too few spares, customer demand, customer service, equipment sparing processes and vendor quality. What is needed is an inventory management and network operations system and method that relies less on human beings to gather data manually and more on at least partially automated input.

Radio-frequency identification (RFID) enabled inventory management systems do exist. However, such systems rely on RFID tags affixed to the containers (e.g., crates, boxes or packages) that contain equipment; the RFID tags are not attached to the equipment itself and therefore do not stay with the equipment after it is unpacked for deployment. As a result, current RFID enabled systems provide no visibility to installed equipment, no validation that equipment delivered to a particular location is actually installed and put into use, generate no alerts when equipment is “lost” between delivery and installation, no correlation between a network fault and defective equipment, no automatic verification of spares availability within service vehicles for dispatch, no automatic validation of tools required within service vehicles for dispatch, no verification of service vehicle location in choosing the optimal service vehicle for dispatch and no location of equipment with bin-level granularity. Current RFID enabled systems may also fail to provide other information or alerts of value.

In contrast, an RFID enabled inventory management and network operations system or method constructed or carried out according to the principles of the invention calls for one or both of the following. First, RFID tags are associated with (typically affixed to) the equipment itself. (Recall that the term equipment also includes parts for equipment.) The container, crate, box, package or envelope that contains the equipment may or may not have its own RFID tag, but that tag is relatively unimportant. Second, the equipment is tracked not only by means of a tag identifier (e.g., a number) retrieved from its RFID tag, but also by a network identifier retrieved through the network to which the equipment has been deployed, typically in accordance with a network management protocol such as the well-known Simple Network Management Protocol (SNMP). Thus, the tag identifier (e.g., serial number and vendor) is the same as, or at least associated with, the network identifier (e.g., serial number and vendor) the equipment provides in response to the appropriate query from the target network. A database (not shown) can contain such associations.

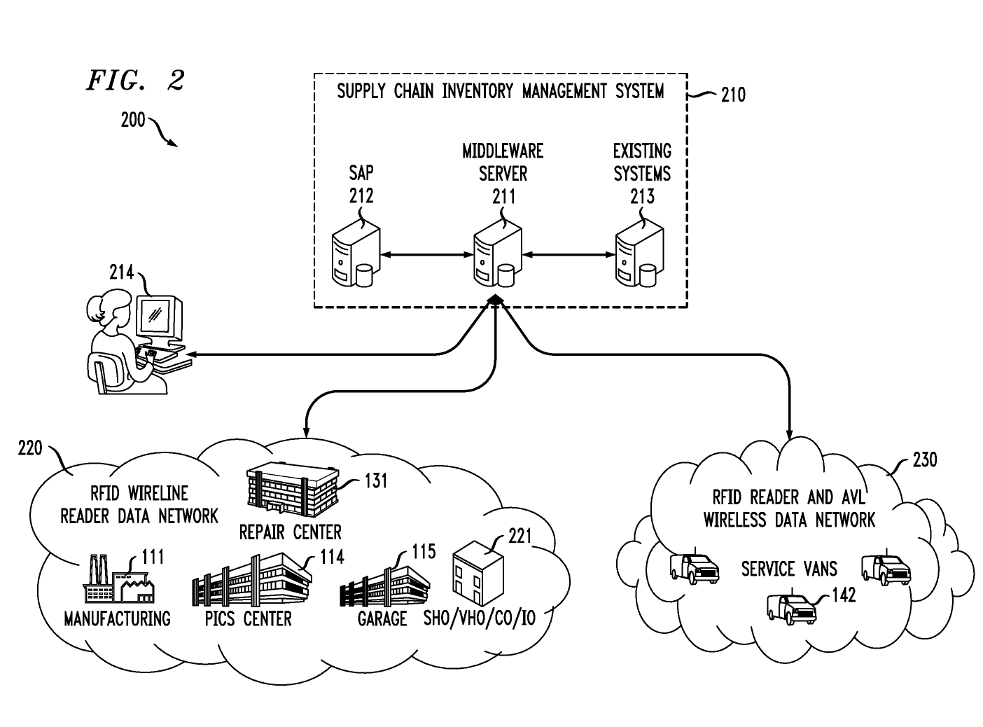

FIG. 2 is a block diagram illustrating one embodiment of an RFID enabled inventory management and network operations system, generally designated 210, constructed according to the principles of the invention and operating in the context of a particular service provider, generally designated 200. The system 210 may includes multiple servers that have associated databases and execute software instructions to perform one or more of the functions described herein.

A middleware server 211 contains RFID middleware for receiving and managing RFID reader data networks such that other systems can make use of it. In the illustrated embodiment, the middleware is a software application that provides interfaces to all RFID readers and collects RFID tag data. While many commercially available software applications provide suitable interfaces, in a more specific embodiment, the software application is Catamaran®, which is commercially available from Shipcom Wireless Corporation of Houston, Tex.

The middleware server 211 exchanges pertinent data with an enterprise resource planning (ERP) system 212 and various other existing systems 213. As FIG. 2 indicates, the system 212 may be an ERP system using SAP®, which is commercially available from SAP GmbH of Walldorf, Germany. As those skilled in the art are aware, most ERP systems are capable of tracking assets, including inventories of equipment, as they traverse a supply chain, generating stock transfer requests and printing shipping labels. The existing systems 213 may include other inventory management systems, accounting systems, notification and alert generation systems, report generating systems, and the like.

A network operations center (NOC) 214 operates a network operation system (NOS), which manages the operation of the service provider's target network. The NOC typically includes a staff of agents, as shown. The staff and NOS are responsible for receiving information regarding the operation of the target network and responding to it, including issuing orders calling for the deployment, repair or removal of equipment.

An RFID reader (wireline) data network 220 encompasses at least part of the overall supply chain and includes the manufacturing plant 111, repair center 131, PICS center 114 and garage 115 of FIG. 1 and various of the service provider's equipment offices, such as a super head-end office (SHO), video head-end office (VHO), central office (CO) and intermediate office (IO). All of these types of offices are collectively designated as 221, although a given service provider may only have some of these types of offices.

An RFID reader wireless data network 230 complements the RFID reader data network 220 and encompasses mobile locations, such as service vehicles 142, trucks, forklifts and even people (not shown). In the embodiment of FIG. 2, the RFID reader wireless data network 230 also includes an automatic vehicle locator (AVL) wireless network, which typically employs data received wirelessly from global positioning satellite (GPS) receivers to locate vehicles with which the GPS receivers are associated. Together, the RFID reader data network 220 and the RFID reader wireless data network 230 provide comprehensive RFID tag reading capability for the system 210.

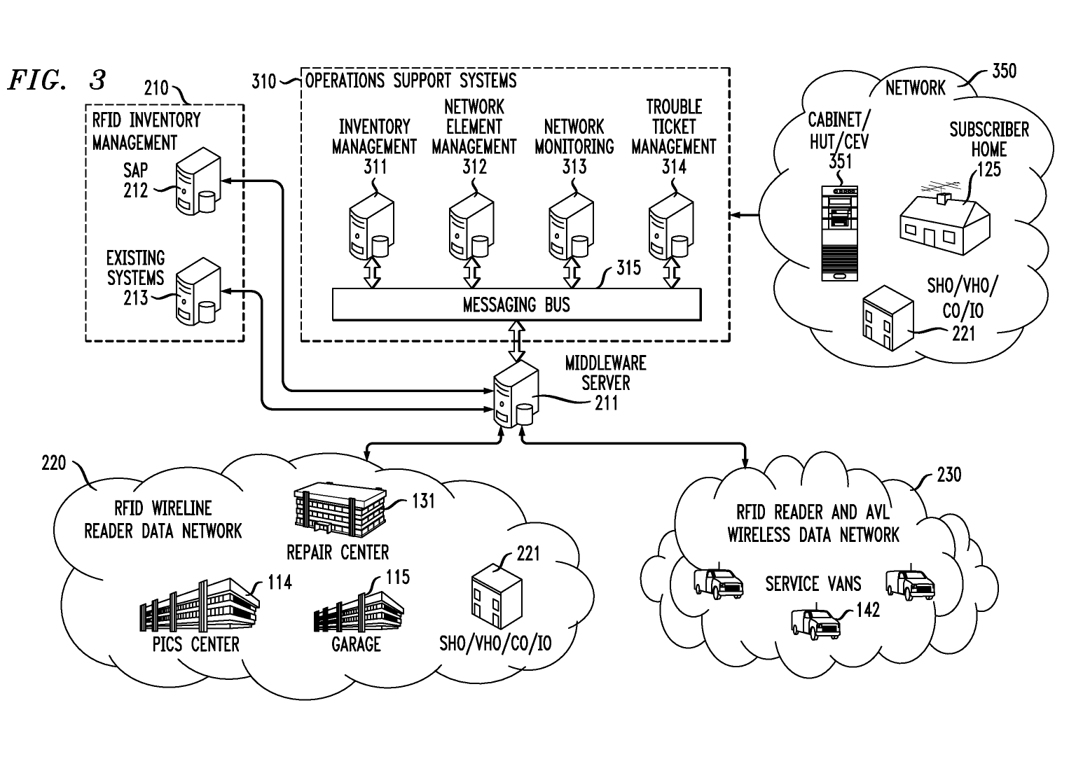

FIG. 3 is a more detailed block diagram of one embodiment of the RFID enabled inventory management and network operations system of FIG. 2, illustrating, in particular, various operations support systems 310 that may cooperate with the system 210. Note that FIG. 3 shows the middleware server 211 as being outside of the system 210. The invention does not require any particular servers to be inside or outside of the system 210.

An inventory management system 311 is designed to manage inventories of equipment, among other things, and is often responsible for managing access to and reordering of inventories. The system 210 can communicate with the inventory management system 311 via, for example, a messaging bus 315 to provide automatic inventory updates.

A network element management system 312 is designed to manage the elements (logical network entities embodied in portions of, pieces of or collections of physical equipment) of the target network. The system 210 can communicate with the network element management system 312 to indicate, for example, whether or not uninstalled equipment may be available to reconfigure the target network for improved performance or increased capacity.

A network monitoring system 313 is designed to monitor the operation of the target network, typically employing a network management protocol such as SNMP. The network monitoring system 313 can communicate to the system 210 to indicate, for example, when a piece of equipment appears faulty.

A trouble ticket management system 314 is designed to generate, track and close trouble tickets (i.e., records of repairs to be made). The system 210 can communicate with the trouble ticket management system 314 to cause trouble tickets to be generated, track, update and close trouble tickets.

FIG. 3 also shows the target network 350 itself and indicates that equipment deployed in the target network 350 may be installed in cabinets, “huts” and controlled environment vaults (CEVs) 351 that commonly exist outside of SHOs, VHOs, COs and IOs.

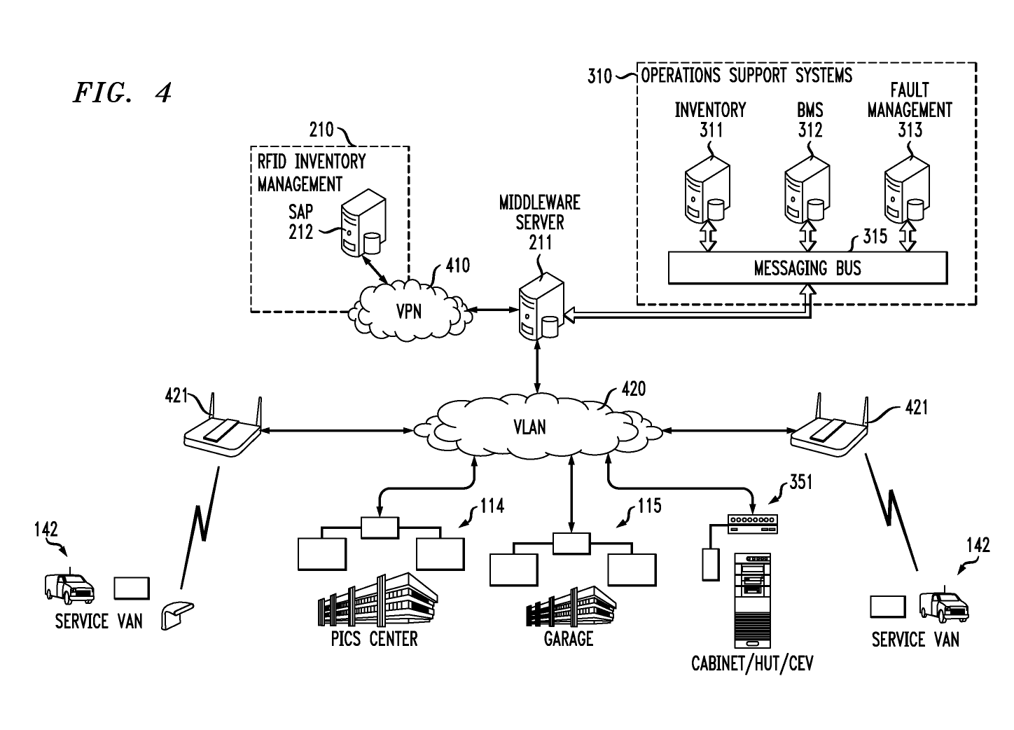

FIG. 4 is a block diagram of an example RFID enabled inventory management and network operations system constructed according to the principles of the invention. FIG. 4 is presented primarily for the purpose of showing physical interconnections that may exist among the various elements called out in FIGS. 2 and 3. Namely, a virtual private network (VPN) 310 may couple the ERP system 212 and the middleware server 211, allowing the two to be physically remote from one another. Likewise, a virtual local area network (VLAN) 420 containing wireless routers 421 may embody the RFID reader wireline and wireless data networks 220, 230.

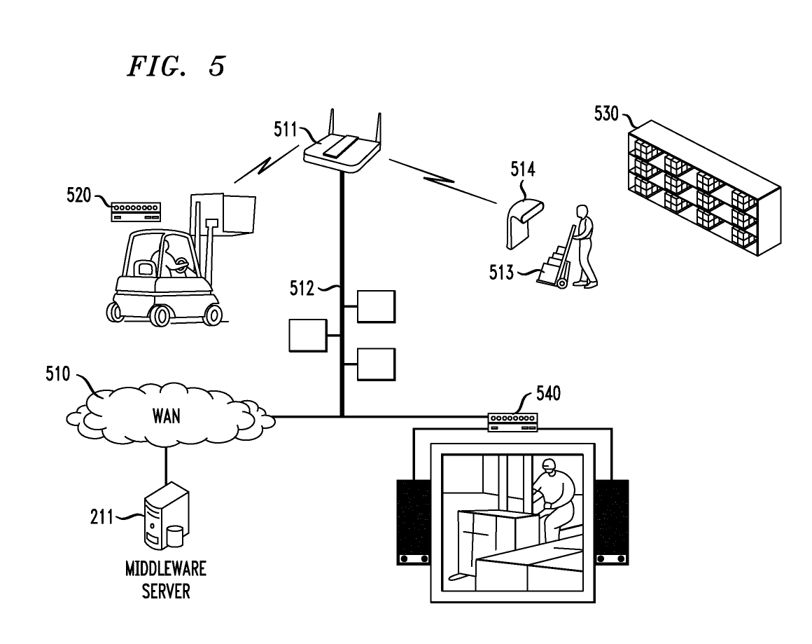

FIG. 5 is a block diagram of a PICS center/garage RFID portion of the RFID enabled inventory management and network operations system of FIG. 2. A wide-area network (WAN) 510 now couples the middleware server 211 to readers associated with a given PICS center or garage. A wireless router 511 and other wireless routers 512 receive tag identifiers. Equipment loaded on a hand cart 513 may be read with a hand-held RFID reader 514 and relayed to the wireless router 511. The wireless router 511 may also receive tag identifiers received from a mobile RFID reader 520 mounted on a forklift. Shelves 530 containing equipment bearing RFID tags may provide further tag identifiers. A fixed-location RFID reader 540 may likewise gather tag identifiers.

A well-covered PICS center or garage might have RFID readers at all entrances and exits, RFID readers at the loading docks, automatic check in and out of inventory by matching employee identification badges with the equipment that leaves or enters and fork lifts outfitted with mobile RFID readers.

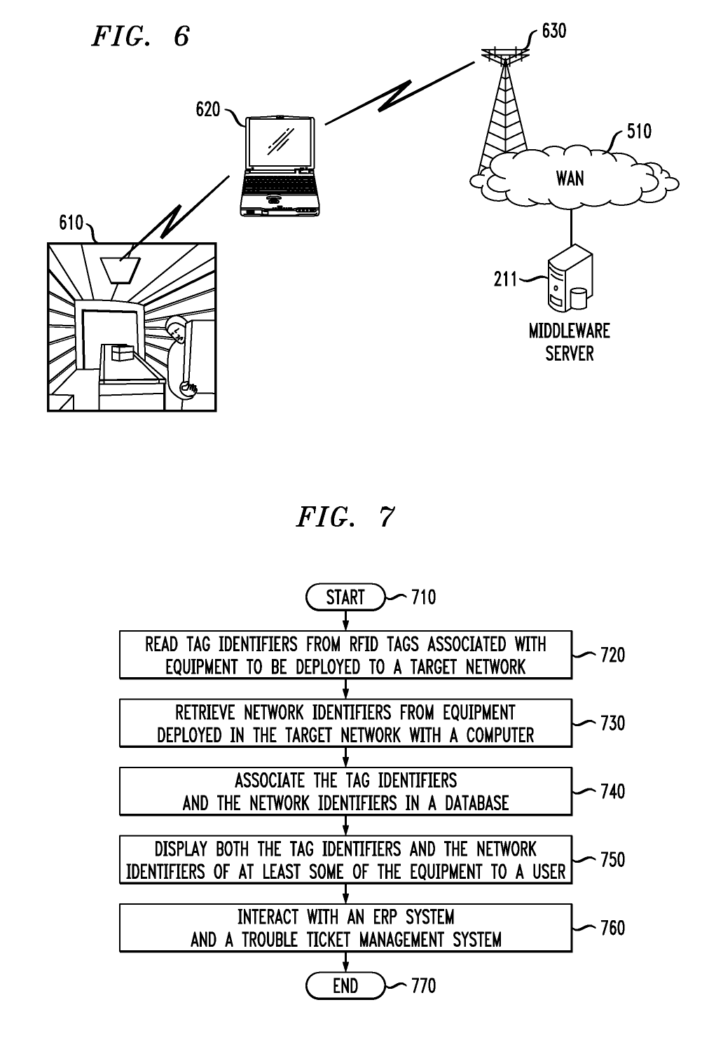

FIG. 6 is a block diagram of a mobile RFID portion of the RFID enabled inventory management and network operations system of FIG. 2. The service vehicle 610, which may be, for example, a service/maintenance van or a large truck equipped with a mobile RFID reader system, contains an RFID reader and an AVL 620 that communicate with a wireless cell or hub 630 coupled to the WAN 510.

Having now set forth forward and repair-and-return supply chains and various embodiments and portions of RFID enabled inventory management and network operations systems, and with reference to both FIGS. 1 and 2, an example of the transit of a piece of equipment through the forward and repair and return supply chains 110, 130, including target network deployment and monitoring by network operations, may now be given. The specific piece of equipment in this example is a card designed to mount in a chassis that constitutes a shelf of a rack of equipment.

The card is manufactured in the manufacturing plant 111, and an RFID tag is mounted to the card itself. A tag identifier, which may be a unique number, is contained in, or written into, the RFID tag. Those skilled in the art are familiar with the mounting of RFID tags and how they may contain identifiers.

An RFID reader at a loading dock of the manufacturing plant 111 detects the egress of the card as it is loaded onto a truck (not shown) and sends the information through the RFID reader data network 220 to the system 210. A wireless RFID reader mounted on the truck or a hand-held RFID reader used by the truck's driver likewise detects the loading of the card and sends the information through the RFID reader wireless data network 230 to the system 210. A GPS receiver or other geolocator (not shown) may also send the truck's location to the system 210. The system 210 stores this information, typically with associated time stamps.

The card then travels to the supplier warehouse 112, a value-added reseller (VAR) warehouse 113 by various vehicles and eventually arrives at the PICS center 114, where it is placed on a shelf or in a bin with similar cards and held ready for deployment. Each time the card is moved and stored, the RFID reader data network 220 and the RFID reader wireless data network 230, whichever is appropriate, sends information regarding the card's location to the system 210, allowing the system 210 to adjust inventory levels accordingly and perhaps generate reorders or alerts for the manufacture or delivery of further cards. In like manner, the system 210 receives RFID identifiers and other information regarding many pieces of equipment. The system 210 also receives GPS or other location information regarding repair vehicles, which may be employed to improve vehicle response times.

After some time has passed, the NOC 141 initiates an order to make a repair to the target network that involves the card (or one like it). Specifically, by means of network monitoring software and information received through SNMP queries, the NOC 141 has identified a faulty card at one of the installations 121-126. Using the system 210, the NOC 141 finds the repair vehicle that is best suited to respond to the matter (perhaps one that has to travel the shortest distance, or perhaps one that already has such a card on board, or perhaps the one that has the appropriate test equipment or trained technician on board). In this example, however, no repair vehicle has such a card on board. Thus, the repair vehicle best suited to respond the matter happens to be located close to the PICS center 114. The NOC 141 dispatches the repair vehicle to the PICS center 114, where an appropriate individual takes the card (which will now be called a “replacement card”) from inventory and places it in the service vehicle. As always, the system 210 receives information that allows it to track the replacement card (and the location of the service vehicle).

It is then assumed that the service vehicle arrives on time at the appropriate installation 121-126. (If the service vehicle is delayed or deviates materially from its authorized route, the system 210 can so note and report to the NOC 141.) A technician then removes the faulty card and installs the replacement card. An SNMP query generated automatically or in response to the detected removal of the faulty card retrieves a network identifier stored in the replacement card (typically contained in nonvolatile memory on the card) and so informs the system 210. The system 210 notes that the network identifier matches the tag identifier associated with the replacement card that was dispatched in the service vehicle, and so confirm that the correct replacement card was deployed to the target network. Assuming the replacement card is in good working order, the system 210 so informs the NOC 141, which notes the repair as having been made.

Now the faulty card can enter the repair and return supply chain 130. Information regarding the card's fault may already have automatically been written into its nonvolatile memory, or the technician may have made a manual entry of its fault in a data entry device, or a repair center may have to diagnose and note the fault later. In any case, the faulty card is loaded onto the repair vehicle and so noted by the system 210.

It is assumed that the repair vehicle delivers the faulty card at the end of the day to the vendor repair center 132 (that destination perhaps being based on a determination by the system 210 that the faulty card is in warranty). RFID readers associated with the repair vehicle and the vendor repair center 132 detect ingress of the faulty card to the vendor repair center 132 and report the same to the system 210. Personnel at the vendor repair center 132 then repair or diagnose and repair the faulty card, whereupon it is perhaps forwarded to the vendor spares depot 135 or the PICS center 114 by way of the mobile and fixed resources 133, 134 owned and operated by a logistics vendor. If a later attempted deployment of the repaired card results in a subsequent fault, the system 210 may compare that fault with the earlier fault or with faults in like cards, perhaps calculating a useful life or mean time between failure (MTBF), identifying a pervasive manufacturing defect, rough supplier or VAR transportation, substandard supplier or VAR storage, poor repair practice on the part of the vendor repair center 132 or one of its personnel, poor installation practices by a technician, and so on. It is straightforward to see that, through the cooperation of the RFID tags associated with equipment, and the information obtained through queries via the target network of deployed equipment, the system 210 is capable of amassing a broad and comprehensive array of information regarding the movement of equipment from manufacture, through deployment and repair and to retirement and eventual destruction. Those skilled in the art will also see that the system 210 is capable of providing a vast array of different views, alerts and reports by a graphical user interface (GUI) on a display screen, by paper or by other media. Those views, alerts and reports may advantageously and significantly enhance the operation of the target network and reduce the cost of such operation.

FIG. 7 is a flow diagram illustrating one embodiment of an RFID enabled inventory management and network operations method carried out according to the principles of the invention. The method begins in a start step 710. In a step 720, tag identifiers are read from RFID tags associated with equipment to be deployed to a target network. In a step 730, network identifiers are retrieved by a computer from equipment deployed in the target network. In a step 740, the tag identifiers and the network identifiers are associated with each other in a database. In a step 750, both the tag identifiers and the network identifiers of at least some of the equipment are displayed on a display device to a user. The display device may be of the computer itself or connected to the computer by a network. In a step 760, the computer interacts with an ERP system and a trouble ticket management system to manage equipment inventory and network operations. The method ends in an end step 770.

Those skilled in the art to which the invention relates will appreciate that other and further additions, deletions, substitutions and modifications may be made to the described embodiments without departing from the scope of the invention.

What is claimed is:

1. An inventory management and network operations system, comprising:
a radio-frequency identification (RFID) reader data network having RFID readers configured to read tag identifiers from RFID tags associated with equipment to be deployed to a target network; and
a computer coupled to said RFID reader data network and said target network and configured to retrieve said tag identifiers from said RFID reader data network and network identifiers from equipment deployed in said target network, associate said tag identifiers and said network identifiers and display both said tag identifiers and said network identifiers of at least some of said equipment to a user.

2. The system as recited in claim 1 wherein said RFID reader data network includes an RFID wireline reader data network and an RFID wireless reader data network.

3. The system as recited in claim 1 wherein said RFID reader data network includes:
fixed-location RFID readers mounted in at least one of:
a manufacturing plant,
a warehouse, and
a repair center, and
mobile RFID readers mounted on at least one of:
a truck,
a service vehicle, and
a forklift.

4. The system as recited in claim 1 wherein said RFID reader data network includes hand-held RFID readers.

5. The system as recited in claim 1 wherein said user is an agent in a network operations center.

6. The system as recited in claim 1 wherein said computer is further configured to interact with an enterprise resource planning (ERP) system.

7. The system as recited in claim 1 wherein said computer is further configured to interact with a trouble ticket management system.

8. An inventory management and network operations method, comprising:
reading tag identifiers from radio-frequency identification (RFID) tags associated with equipment to be deployed to a target network;
retrieving network identifiers from equipment deployed in said target network with a computer;
associating said tag identifiers and said network identifiers in a database; and
displaying both said tag identifiers and said network identifiers of at least some of said equipment to a user.

9. The method as recited in claim 8 wherein said reading is carried out with a RFID reader data network that includes an RFID wireline reader data network and an RFID wireless reader data network.

10. The method as recited in claim 8 wherein said reading is carried out with a RFID reader data network that includes:
fixed-location RFID readers mounted in at least one of:
a manufacturing plant,
a warehouse, and
a repair center, and
mobile RFID readers mounted on at least one of:
a truck,
a service vehicle, and
a forklift.

11. The method as recited in claim 8 wherein said reading is carried out with a RFID reader data network that includes hand-held RFID readers.

12. The method as recited in claim 8 wherein said user is an agent in a network operations center.

13. The method as recited in claim 8 further comprising interacting with an enterprise resource planning (ERP) system.

14. The method as recited in claim 8 further comprising interacting with a trouble ticket management system.

15. An inventory management and network operations system, comprising:
a radio-frequency identification (RFID) reader data network having RFID readers configured to read tag identifiers from RFID tags associated with equipment to be deployed to a target network; and
a computer coupled to said RFID reader data network and said target network and configured to retrieve said tag identifiers from said RFID reader data network and network identifiers from equipment deployed in said target network, associate said tag identifiers and said network identifiers and display both said tag identifiers and said network identifiers of at least some of said equipment to a user and allow said user to track equipment as said equipment moves through a supply chain of said network and as said equipment is removed from said network, repaired and returned to said network.

16. The system as recited in claim 15 wherein said RFID reader data network includes an RFID wireline reader data network and an RFID wireless reader data network.

17. The system as recited in claim 15 wherein said RFID reader data network includes:
fixed-location RFID readers mounted in at least one of:
a manufacturing plant,
a warehouse, and
a repair center,
mobile RFID readers mounted on at least one of:
a truck,
a service vehicle, and
a forklift, and
hand-held RFID readers.

18. The system as recited in claim 15 wherein said user is an agent in a network operations center.

19. The system as recited in claim 15 wherein said computer is further configured to interact with an enterprise resource planning (ERP) system.

20. The system as recited in claim 15 wherein said computer is further configured to interact with a trouble ticket management system.
